(19) United States
(12) Patent Application Publication
(10) Pub. No.: US 2004/0117050 A1
(43) Pub. Date: Jun. 17, 2004

(54) Graphical overall equipment effectiveness system & method

(76) Inventors: John Oskin, Chicago, IL (US); David T. Boctor, Chicago, IL (US)

Correspondence Address: BARNES & THORNBURG, P.O. BOX 2786, CHICAGO, IL, 60690-2786, US

(21) Appl. No.: 10/685,084

(22) Filed: Oct. 14, 2003

Related U.S. Application Data
(60) Provisional application No. 60/418,608, filed on Oct. 15, 2002.

(51) Int. Cl. G06F 19/00

(52) U.S. Cl. 700/108

(57) ABSTRACT

A method, computer readable medium or modulated signal, and system for monitoring the operational efficiency of equipment. Performance and scheduling data is used to calculate an overall equipment effectiveness, performance loss value, and quality loss value. These values are displayed in a graphical format display, such as in a pie chart, to visually indicate what percentage of a maximum planned product time is actually devoted to producing product. The graphical format display shows the productivity diminishing factors in a simple format to allow both operators and management to quickly analyze production. The system may include multiple sensors and multiple terminals for retrieving data and graphically displaying overall equipment effectiveness information.

### CROSS-REFERENCE TO RELATED APPLICATIONS

This application claims benefit of the U.S. Provisional Application Serial No. 60/418,608, filed Oct. 15, 2002. The Provisional Application is incorporated herein by reference.

### BACKGROUND

Manufacturers today often seek to measure the efficiency and productivity of equipment in their facilities. One methodology for measuring such efficiency in use today is calculating an “Overall Equipment Effectiveness” value or “OEE” to track production performance. OEE is used throughout the process, batch, and discrete production plans and is a vital part of lean manufacturing.

OEE tracks the value added productivity of equipment. It measures the percentage of time equipment is actually making product compared to a theoretical maximum. Displays showing the OEE value along with OEE-determining variables are often shown on a display positioned along side the equipment. Such placement allows both an operator and management to gauge efficiency on-site. Such placement also allows improvements and declines in productivity to be readily measured and identified.

OEE is calculated using certain assumptions and by viewing historical data about production availability, performance, and quality as is well known in the art. Many of these variables may be observed or, alternatively, measured using sensors attached to manufacturing equipment. Calculating the availability, performance, and quality also requires the input of certain assumptions, such as, for example, “ideal cycle time” which may be defined as the theoretical minimum time between parts, and “ideal run rate” which may be defined as the theoretical maximum production rate.

Although the OEE value is a useful index in accessing production performance, the OEE value itself fails to quickly provide in an easy-to-read, graphical manner, information about specific conditions contributing to productivity loss. It is desirable to have such information presented at a level understandable to the average equipment operator on the manufacturing floor so that such an operator can monitor or benchmark their productivity.

Briefly, and in accordance with the foregoing, the present disclosure relates to a method, computer-readable medium or modulated signal, and system for monitoring an operational efficiency for equipment. The system includes a module for operating a computer to receive OEE-determinative values, calculate OEE related variables, and display a graphical representation of OEE data to at least one output device.

Also disclosed is a method for displaying simplified OEE data which includes a number of steps beginning with retrieving or inputting assumption values. The method further includes steps to retrieve production data, to calculate OEE, and to calculate simplified OEE data. Simplified OEE Data is then displayed in a graphical format display on an output device.

Additional features will become apparent to those skilled in the art upon consideration of the following detailed description of drawings exemplifying the disclosure as presently perceived.

### BRIEF DESCRIPTION OF THE DRAWINGS

The detailed description particularly refers to the accompanying figures in which:

FIG. 1 is a simplified diagrammatic view of a system for calculating and displaying visual OEE;

FIG. 2 is a diagrammatic flowchart of steps for calculating and displaying visual OEE;

FIG. 3 is a diagrammatic flowchart of steps to calculate simplified visual OEE determinative values; and

FIG. 4 is one embodiment of a graphical OEE display.

### DETAILED DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

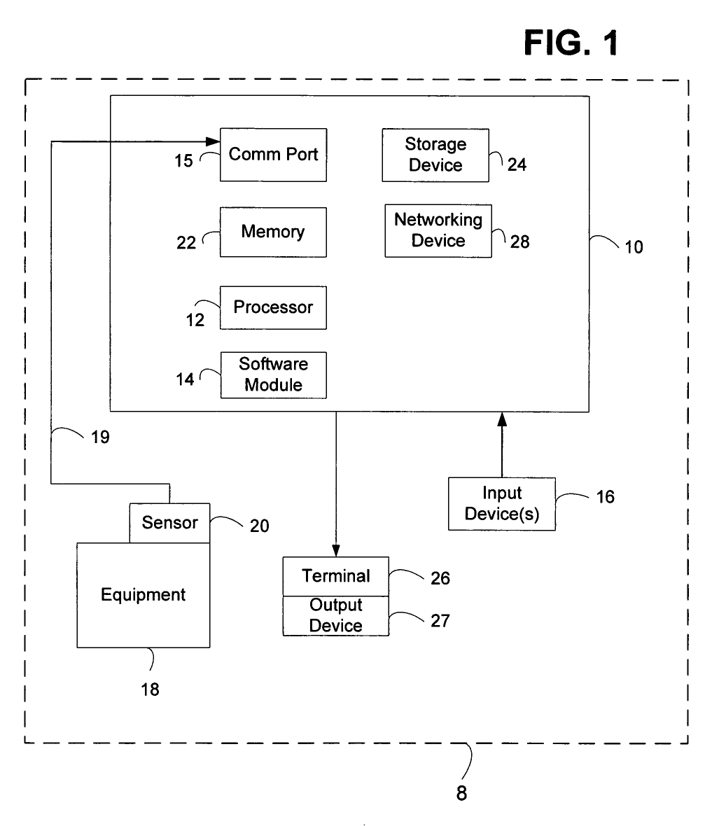

With reference to the figures, FIG. 1 shows a simplified diagrammatic illustration representing a system 8 for calculating and displaying simplified OEE data. The system 8 includes a general purpose computer 10 of known construction. The computer 10 includes a processor 12 which is programmed by a software module 14 to perform the necessary calculations and transformations needed to produce simplified OEE data in a graphical format, for example in the form of a pie chart. It is envisioned that other forms of graphical information could be obtained from the system 8. For purposes of this disclosure, the various graphical formats the simplified OEE data may be displayed as are referred to collectively as a graphical format display. For convenience, the one embodiment shown is a pie chart with OEE-related factors shown as wedges.

System 8 further includes input device 16, such as for example, a keyboard, or mouse, for inputting simplified OEE data determining values. These values may be based on observed figures, such as production rates of a piece of manufacturing equipment 18 or on operator assumptions such as maximum produced units per cycle. In another embodiment, production equipment 18 is monitored by a sensor 20, in networked communication with computer 10 via a communications port 15 configured therein. Sensor 20 may be constructed using any industry-known construction method, for example an electrical sensor for detecting an on or off state, or a motion sensor for detecting movement of equipment, products, or product components. Sensor 20 is in reporting communication with equipment 18. Sensor 20 monitors up-time and down-time statistics, records historical production-related values, such as for example, a number of items produced or processed for a particular run cycle and transmits such statistics and data to computer 10 via line 19. It should be noted that line 19 is a communication path for the reporting communication and may be achieved by hardwire, RF, optical, acoustic, or any other networked communication types whether wired or wire-less. Values represented by these inputted or observed figures may be stored in the computer's memory 22 or storage device 24 such as, for example, a floppy disk, CD-ROM, CDR, DVD, DVDr, DVD+RW, tape, memory stick, or hard drive.

One or more software modules 14 may be stored on the storage device 24 or in memory 22, and may be stored and loaded from computer-readable media, such as a floppy disk, CD-ROM, or the like. Module 14 may also be loaded by download via a modulated signal received from another computer. Software module 14 include computer readable code for operating the processor 12 to perform necessary calculations, I/O functions, and so forth. The term “module” referenced in this disclosure is meant to broadly cover various types of software code, including but not limited to routines, functions, objects, libraries, classes, members, packages, procedures, or lines of code together performing similar functionality to these types of coding. The steps may be performed with a stand-alone program written in languages such as C++, Java, Fortran, Visual Basic or be implemented using a scripting language which supplements an off-the-shelf software package or database such as, by way of example but not limitation, SQL Server or Access from Microsoft Corporation, used for operating computers and other types of computerized equipment.

System 8 further includes at least one terminal 26 in networked communication with computer 10. Each terminal includes an output device 27 such as a computer monitor of known construction, or any other output device capable of showing graphics in dimensions sufficient to display graphical formats such as a pie chart. Each terminal 26 may be a separate 26 computer system of known construction programmed to receive information to display graphical information from computer 10, or terminal 26 may be a “dummy” terminal that simply functions to network to computer 10 and display data on the output device 27.

Optionally, a networking device 28, such as a network card, may also be configured in computer 10, for communicating with other systems or communicating with one or more terminals 26. Such a configuration may useful when the processing functions are performed by an Application Service Provider or the like. Terminals 26 may be positioned at the location where an operator will operate the machine, an operational location. Depending on the type of equipment in use, the operational location may be next to the equipment or at a distance. The terminal may be positioned such that the operator can view the output device 27 while operating the machine.

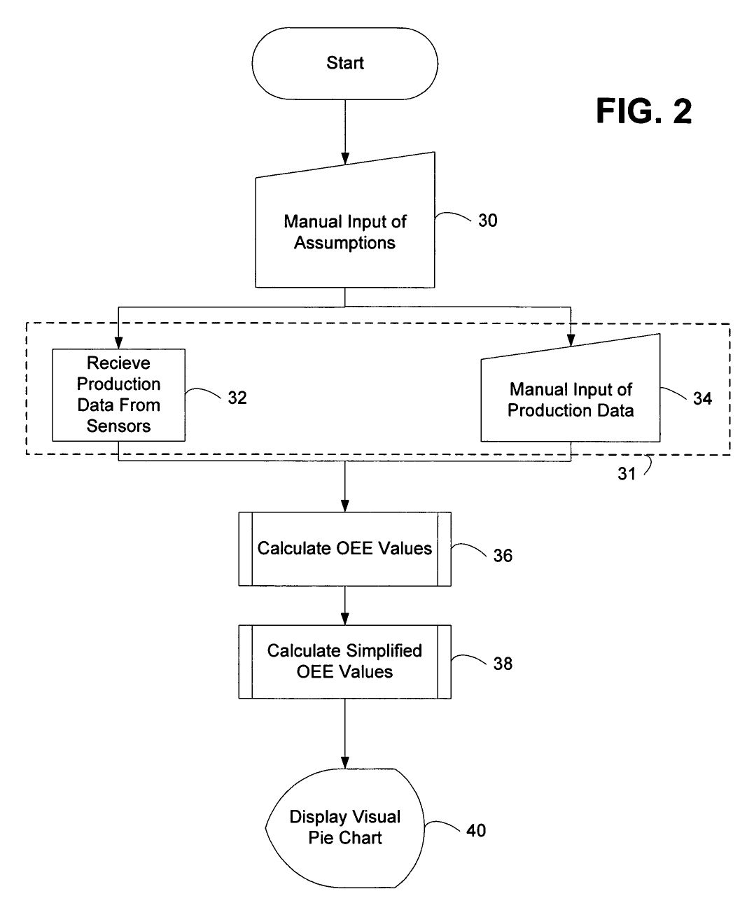

The general method for calculating and displaying a simplified OEE data pie chart is shown in FIG. 2. Assumptions 30 are inputted into the system 8. Alternatively, previously entered assumption 30 may be retrieved from memory 22 or storage device 24. These assumptions are used in the calculation of at least three values: availability, performance, and quality, which are used to calculate OEE. As example of a required assumption is used in the calculation of availability, defined as operating time divided by the planned production time. Planned production time is defined as the total time that equipment is expected to produce. Events such as planned down time, lunches, and breaks would thus reduce planned production time. Planned production time is thus an assumption inputted for the purpose of calculating OEE. Other values, such as “ideal rate” are similarly inputted or retrieved as assumptions 30.

Next, observed values 31 are inputted into the system 8. Observed values 31 may be either entered manually 34, or received via sensors 32. Examples of observed values 31 used in calculating OEE include “down time”, or “processed amount” which is generally the quantity or weight of products produced, “number of defective products,” “number of good products,” and so forth.

Three components are used to determine OEE 36. They are “availability”, “performance” which is also known as Cycle Erosion™, and “Quality” which may also be known as “quality erosion.” These values are calculated as follows:

TABLE I

| Value | Calculation |
|---|---|
| OEE | Availability × Performance × Quality |
| Availability | (Available Time − Down Time) / Available Time |
| Performance | (Available Time × Processed Amount) / |
| (Cycle Erosion ™) | Ideal Cycle Time |
| Quality | (Processed Amount − Defect Amount) / |
| (Quality Erosion) | Processed Amount |

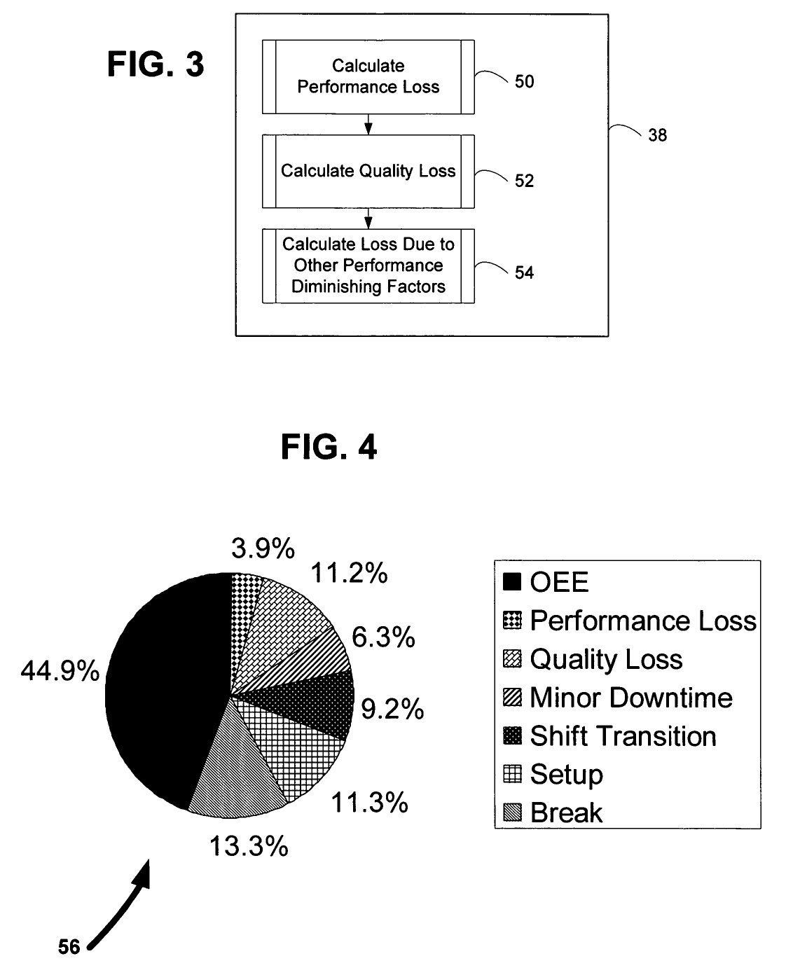

In general, downtime losses can be calculated by adding together the amount of time lost due to equipment failures, setup and adjustments, idling, and minor equipment stoppage. Quality erosion is a measurement of the amount of product that is produced during production which matches production specifications. Quality erosion is calculated as shown above, but may conceptually be thought of as representing the effectiveness to produce defect-free product. One example of a major losses in quality erosion is from defective product resulting from scrap and rework as well as start-up defects. The Defect Amount is the number of defective units. In a pie chart embodiment of the graphical representation of the data, the OEE 36 and OEE determining values described above are then transformed into simplified OEE values 38 which will determine the size of the wedge in the pie chart 40. It should be noted that pie chart 40 may take other forms such as, for example, a line chart or histogram, but is hereinafter referred to as pie chart 40 for convenience. As shown in FIG. 3, such data includes a performance loss 50 and a quality loss 52 which are determined according to the following calculations:

| Transformed Value | Calculation |
|---|---|
| Performance Loss | Units Processed / Design Speed Rate |
| Quality Loss | Rejects / Design Speed Rate |

The simplified OEE data may also include losses to maximum OEE represented by other performance diminishing factors 54 which include but are not limited to breaks, lunches, setup, delay due to the start and end of a particular shift, i.e. a shift transition, and minor downtime. The value for the design speed rate is an assumption provided for the number of products that are produced for a given interval, for example, products per minute or products per hour.

The values discussed above may then expressed in terms of hours for comparison with planned production time. So, for example, if the planned production time for a piece of equipment in a given production cycle is 66.09 hours, the sum of the OEE, Performance Loss, Quality Loss, and performance diminishing factors 54 will equal 66.09 hours. The hour values of each of the OEE, Performance Loss, Quality Loss, and performance diminishing factors may be converted into a percentage of the maximum possible uptime. Using a planned production time of 66.09 hours, an example of Pie chart determining factors is as follows:

TABLE III

| Category | Hours | Percentage |
|---|---|---|
| Efficiency (OEE) | 42.83 | 64.8 |
| Performance Loss | 10.80 | 16.3 |
| Quality Loss | .85 | 1.3 |
| Performance Diminishing | 11.61 | 17.6 |
| Factors | | |
| TOTAL | 66.09 | 100% |

The percentages are then displayed as wedges in a pie chart 40. The dimension of each wedge is proportional to the percentage that value represents of the whole. The display may also include a legend explaining the meaning of each wedge. An example of pie chart 56 is shown in FIG. 4.

In use, the pie chart 40 is displayed on an output device at the operational location. In general, the OEE portion of the pie chart 40 shows the productive portion of planned production time and each of the other categories shows factors negatively impacting productivity. An operator, even with their limited understanding of efficiency theory, lean manufacturing, ideal rate, or whatever other value may be of interest to engineering or management, can easily understand the following simple visually displayed concept. An operator wants to make the OEE wedge “bigger” and the other wedges smaller. An operator can see which non-OEE wedge is “big” and take steps accordingly. For example, if a wedge representing setup time looks “too big” to an operator, the operator may take some corrective action to improve the OEE value. Corrective action includes but is not limited to finding a more efficient method for equipment setup and reducing delays due to shift transitions.

Management or engineering may also benefit from the pie chart 40 by similarly being presented with which factors are causing inefficiency. Management can then take action to reduce the values that diminish the OEE value such as by adjusting scheduling. Managers may also reward operators who improve efficiency with incentives such as bonuses or favorable employment reviews.

A key factor in determining which wedges produce a particular percentage is the calculation of the maximum planned production time (“PPT”) for a given piece of equipment. Calculating the PPT itself requires a number of assumptions and observed values. An advantageous method of determining maximum PPT is to scan through historical data to find a true historical maximum. Also, such selective historical data analysis may be focused on particular durations of a cycle or production process. Such durations may include, for example, one day of operation, a complete shift, an A.M. or P.M. shift, a week, a month, and so forth. Continuously redefining the PPT value may improve the diagnostic accuracy of the simplified OEE data and pie chart related thereto.

The foregoing example and other examples set forth in this description are not intended in any way to limit the scope of the present applications and appended claims. Rather, these are provided as examples to further help understand and enable the described device, method and system. These examples are intended to be expansive to be broadly interpreted without limitation. It is envisioned that those of ordinary skill in the art may devise various modifications and equivalents without departing from the spirit and scope of the disclosure. Various features have been particularly shown and described in connection with the disclosure as shown and described, however, it must be understood that these particular arrangements and methods merely illustrate, and that the disclosure is to be given its fullest interpretation within the terms of the appended claims.

1. A method for monitoring operational efficiency of equipment in a, the method comprising the steps of:
calculating an availability value;
calculating a performance value;
calculating a quality erosion value;
defining an overall equipment effectiveness value as the product of the availability value, the performance value, and the quality erosion value;
calculating a performance loss value;
calculating a quality loss value;
displaying the overall equipment effectiveness value, the performance loss value, and the quality loss value in a graphical format display.

2. The method of claim 1, further comprising the step of converting the overall equipment effectiveness value, the performance loss value, and the quality loss value to a percentage of a maximum planned production time prior to being displayed in a graphical format display.

3. The method of claim 2, further comprising the step of displaying the graphical format display as a pie chart having a plurality of wedges, the plurality of wedges including at least a wedge corresponding to the overall equipment effectiveness value, a wedge corresponding to the performance loss value, and a wedge corresponding to the quality loss value, wherein each wedge in the plurality of wedges has a dimension proportional to the wedge's corresponding value.

4. The method of claim 3, further comprising the step of displaying the plurality of wedges further comprises performance diminishing values expressed as a percentage of a maximum planned production time.

5. The method of claim 4, further comprising the step of having the performance diminishing values be a break value, a setup value, a shift transition value, and a minor downtime value.

6. The method of claim 2, further comprising the step of improving operational efficiency by examining the graphical format display and adjusting scheduling to reduce values that diminish the overall equipment effectiveness value.

7. The method of claim 2, further comprising the step of improving operational efficiency by having an operator view the graphical format display and having the operator take corrective action to improve the overall equipment effectiveness value.

8. The method of claim 7, further comprising the step of having the corrective action be reducing the duration of a break.

9. The method of claim 7, further comprising the step of having the corrective action be reducing equipment setup time.

10. The method of claim 7, further comprising the step of having the corrective action be reducing delays due to shift transitions.

11. The method of claim 7, further comprising the step of rewarding an operator who improves the overall equipment effectiveness value.

12. The method of claim 7, wherein an output device for displaying the graphical format display is positioned alongside the operator.

13. A computer-readable medium or modulated signal being encoded with computer-readable instructions to perform a method of monitoring operational efficiency comprising:
calculating an availability value;
calculating a performance value;
calculating a quality erosion value;
defining an overall equipment effectiveness value as the product of the availability value, the performance value, and the quality erosion;
calculating a performance loss value;
calculating a quality loss value;
displaying the overall equipment effectiveness value, the performance loss value, the quality loss value, in a graphical format display.

14. A system for monitoring operational efficiency of equipment, the system comprising:
a module that:
calculates an availability value;
calculates a performance value;
calculates a quality erosion value;
defines an overall equipment effectiveness value as the product of the availability value, the performance value, and the quality erosion value;
calculates a performance loss value;
calculates a quality loss value;
displays the overall equipment effectiveness value, the performance loss value, the quality loss value, in a graphical format display.

15. A system for monitoring the operational efficiency of a plurality of equipment, the system comprising:
a module that calculates an availability value, calculates a performance value, calculates a quality erosion value, defines an overall equipment effectiveness value as the product of the availability value, the performance value, and the quality erosion value, calculates a performance loss value, and calculates a quality loss value; and
a plurality of terminals in networked communication with the module, each of the plurality of terminals being positioned at an operator location for each of the plurality of equipment, each terminal having an output device for displaying at least the overall equipment effectiveness value, the performance loss value, and the quality loss value in a graphical format display.

16. The system for the monitoring the operational efficiency of equipment, the system comprising:
a sensor in reporting communication with the equipment for monitoring at least the up-time and down-time for the equipment; and
a module in electrical communication with the sensor and receiving data from the sensor, the module operative to:
use the data to calculate an availability value;
use the data to calculate a performance value;
use the data to calculate a quality erosion value;
define an overall equipment effectiveness value as the product of the availability value, the performance value, and the quality erosion value;
calculate a performance loss value;
calculate a quality loss value; and
display the overall equipment effectiveness value, the performance loss value, and the quality loss value in a graphical format display.

17. The system of claim 16 further comprising at least one additional sensor in reporting communication with at least one additional equipment, each additional sensor in communication with the module.

18. The system of claim 16 further comprising a terminal in networked communication with the module, the terminal being positioned at an operator location for the equipment, the terminal having an output device for showing the graphical format display.

19. The system of claim 18 further comprising at least one additional terminal in networked communication with the module and at least one additional equipment, each additional terminal being positioned at an operator location for each additional equipment.

20. The system of claim 16, wherein the sensor also monitors historical product-related values.
